(19) United States
(12) Patent Application Publication
(10) Pub. No.: US 2018/0084388 A1
(43) Pub. Date: Mar. 22, 2018

(54) Self contained GPS tracking device

(71) Applicant: Allan Askar, Miranda, CA (US)

(72) Inventor: Allan Askar, Miranda, CA (US)

(21) Appl. No.: 15/271,218

(22) Filed: Sep. 20, 2016

(51) Int. Cl. H04W 4/02; H04B 1/3883; G01P 15/00

(52) U.S. Cl. CPC H04W 4/028; H04W 84/12; G01P 15/00; H04B 1/3883

(57) ABSTRACT

The present invention is a tiny, self-powered GPS unit with the ability to track any property for up to 5 years on a single battery. A User simply attaches the unit to any valuable property and immediately find it location through a computer application. The tracking device has an ultra low-power high performance 3-axis “femto” accelerometer, a low-power tiny footprint GPS SoC unit, an ultra low-power SoC unit with WiFi radio, and a battery: 3V 225 mAh (CR2032). The ultra low-power SoC unit with WiFi radio reads GPS location readings from the GPS SoC unit and stores it. The ultra low-power SoC unit with WiFi radio communicates through the Internet or Cloud giving location information to the user.

### CROSS-REFERENCES TO RELATED APPLICATIONS (IF ANY)

None

### BACKGROUND

### 1. Field of the Invention

The invention relates to a device for locating an item in particular, a GPS device that is small with a greater battery life.

### 2. Description of Prior Art

People lose important items such as documents, toy, jewelry and other such valuables all the time.

The market currently has GPS devices for a variety of uses. Some units help users navigate vehicle traffic and find specific places, while others provide asset protection monitoring that alert users in real time if their property has been moved. Other GPS units serve as child locators that can pinpoint a child's whereabouts instantly. Some units have all-in-one features, being able to track people, cars and assets. While GPS devices are useful on many levels, some are not very compact or come with short battery life or hefty price tags.

Many companies have GPS tracking devices with quite impressive sales while still having many disadvantages:

1. Big size,

2. Big weight,

3. Not independent (Need External Power or they have small operating time), and

4. Too expensive (The cheapest unit priced around $40).

Typical GPS modules are available in tiny sizes, but are not self contained. You need to add power, communication modules and main controller modules to make it self contained with no requirements for setup.

There is a need for an alternative tiny, low-cost, self-powered tracking device.

There is still room for improvement in the art.

### SUMMARY OF THE INVENTION

The present invention is a is a tiny, self-powered GPS unit with the ability to track any property for up to 5 years on a single battery.

The unit is simply attached to any valuable property and immediately be able find its location through a application that can run on a person's personal computer device such as a smart phone or tablet,

The current invention is great for construction sites that leave equipment overnight. It can be placed in the bottom of a child's book bag to ensure they are in the right place all the time, It is an accurate, cost-effective method for tracking valuable shipments.

The current invention is more efficient, effective, accurate and functional than the current art.

Components of the Current Invention:

1. Ultra low-power high performance 3-axis “femto” accelerometer.

2. Low-power tiny footprint GPS SoC unit.

3. Ultra low-power SoC unit with WiFi radio.

4. Battery: 3V 225 mAh (CR2032).

5. Device custom firmware.

6. Service custom software.

7. App custom software.

8. Browser.

9. User.

10. Cloud.

11. Mobile personal device.

### BRIEF DESCRIPTION OF THE DRAWINGS

Without restricting the full scope of this invention, the preferred form of this invention is illustrated in the following drawings:

FIG. 1 shows the current invention and its main components.

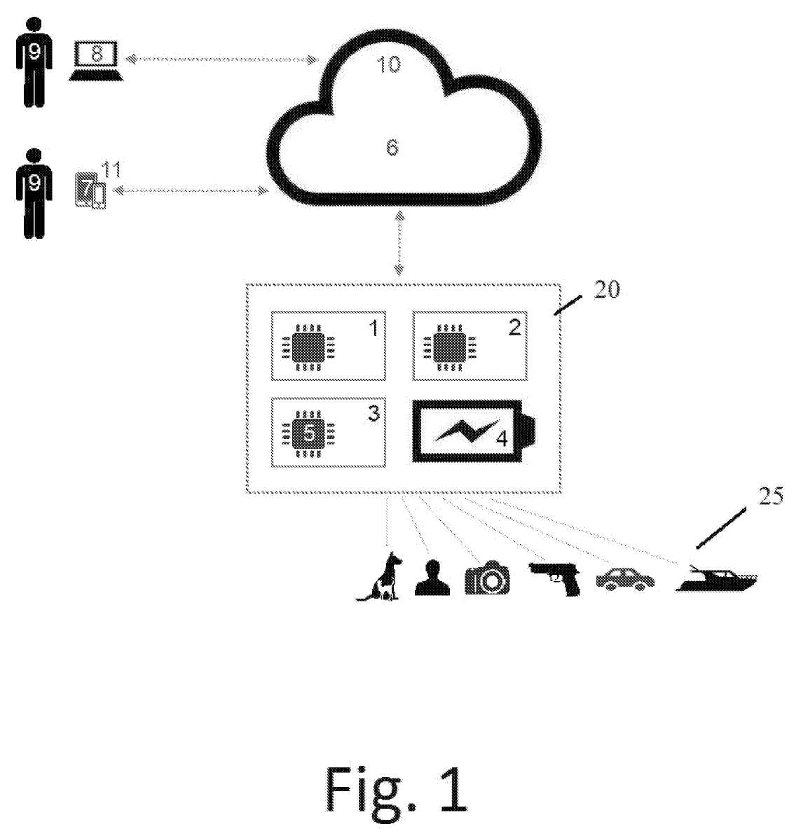

### DESCRIPTION OF THE PREFERRED EMBODIMENT

There are a number of significant design features and improvements incorporated within the invention.

The present invention is a Self contained GPS tracking device with accelerometer, WiFi radio, small battery with a tiny footprint and long life.

The device 20 periodically acquires and stores acceleration sensor readings then, if needed, acquires and stores GPS location readings, then if needed, communicates with cloud based service to exchange data messages. That allows it to operate on a single tiny battery for years and for the owner of the device to control it's behavior and access location, history and configuration data.

External power sources require the typical GPS tracker device to be wired to a physical object but the current invention uses an internal battery designed to last for up to 5 years. This make it very desirable and embedded into any physical objects, even with no power source (Example: any weapon)

Another issue is a size, which makes typical GPS tracking devices hard to embed into objects. The device 20 will be smaller than 24 mm×24 mm×7 mm.

The tracking device 20 has the following components: an ultra low-power high performance 3-axis “femto” accelerometer 1, a low-power tiny footprint GPS SoC unit 2, an ultra low-power SoC unit with WiFi radio 3, a battery such as 3V 225 mAh (CR2032) 4. The tracking device system has device custom firmware 5, service custom software 6 and application custom software 7 in non-transitory memory. The application custom software or app is run on a user's computering device such as a phone 11 or computer browser 8.

The tracker device 20 uses a browser software application to connect to the Internet or Cloud to convey information to the user 9 through their mobile personal device 20 or computer device 8.

The tracking device 20 has the following components: an ultra low-power high performance 3-axis “femto” accelerometer 1, a low-power tiny footprint GPS SoC unit 2, an ultra low-power SoC unit with WiFi radio 3, a battery: 3V 225 mAh (CR2032) 4. The SoC unit 3 reads accelerometer readings from the accelerometer 1 and stores it. The components are within a physical small tag that can be placed on, attached to or built in the item 25 to be tracked. The two or more of the components can be on a single microchip or multiple chips connected to each other.

The ultra low-power SoC unit with WiFi radio 3 reads GPS location readings from the GPS SoC unit 2 and stores it. The ultra low-power SoC unit with WiFi radio 3 communicates through the Internet or Cloud 10 giving location information to the user 9.

Operations:

The device 20 is place on an item 25 that needs to be tracked.

The SoC unit 3 checks internal timers and waits expiration. The accelerometer 1 waits acceleration and if triggered sends interrupt to the SoC unit 3. If the SoC unit 3 has its timer expired then it reads acceleration value from accelerometer 1. If the SoC unit 3 gets an interrupt from accelerometer 1 then it reads acceleration value from accelerometer 1. Then the SoC unit 3 stores acceleration value into non-transitory electronic memory. Then the SoC unit 3 compares current acceleration value and last one from non-transitory electronic memory. If acceleration delta is greater than configured value in the SoC unit 3 then the SoC unit 3 instructs the GPS SoC unit 2 to read the GPS location. If the GPS SoC unit 2 gets GPS location then the SoC unit 3 stores it into electronic non-transitory memory.

Then the SoC unit 3 compares current GPS location and last one from the electronic non-transitory memory. If the GPS location delta is greater than configured value in the SoC unit 3 then the SoC unit 3 updates its configuration. The SoC unit 3 also, checks another internal timer to see if there is a need to communicate.

When communication timer is triggered or the GPS location delta threshold reached, the SoC unit 3 searches for WiFi access points. If found and it connects and then the SoC unit 3 uploads all new data into through the cloud 10 or Internet to the user 9 through a user's computering device such as a phone 11 or computer browser 8.

Also, the SoC unit 3 reads 10 to see if there any updates with a new configuration(s). If there are, then the SoC unit 3 downloads new configuration(s) from cloud 10 or Internet and updates it in the SoC unit's electronic non-transitory memory. The new configurations can be from the user 9 through a user's computering device such as a phone 11

The user 9 connects to the Cloud or internet 10 using a connection means such as a browser 8 and navigates to Service custom software 6. Then, the user 9 accesses device data in the Service custom software 6. The user 9 can read data and update configuration data for device 20. The user 9 starts an application custom software 7 using a smart phone 11 or any other computering device such as a computer with a browser 8. Then, the user 9 accesses device data within the Service custom software 6. The user 9 can read data and update configuration data for the device 20. The data will include the GPS location of the device 20 and thereby the location of the item that the device was place on.

### Advantages

It can never be lost if it's always found!

The current invention is a tiny, self-powered GPS unit with the ability to track any property for up to 5 years on a single battery. A User simply attaches the unit to any valuable property and immediately find it location through the complementary app. It is great for construction sites that leave equipment overnight. It can be placed in the bottom of a child's book bag to ensure they are in the right place all the time. It is an accurate, cost-effective method for tracking valuable shipments.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device for tracking an item comprising:
the component of an accelerometer, a GPS SoC unit 2, SoC unit with WiFi radio, and a battery.

2. The device as recited in claim 1, further comprising:
where the battery is an internal battery.

3. The device as recited in claim 1, further comprising:
where the components are low power.

4. The device as recited in claim 1, further comprising:
where the battery is long lasting battery.

5. The device as recited in claim 1, further comprising:
where the components are connected and place in a tag.

6. The device as recited in claim 5, further comprising:
where the tag is placed on the item to be tracked.

7. The device as recited in claim 1, further comprising:
using a browser software application to connect to the Internet to convey information to the a computering device.

8. The device as recited in claim 1, further comprising:
having the SoC unit read and store accelerometer readings from the accelerometer.

9. The device as recited in claim 1, further comprising:
having the SoC unit check internal timers and waits expiration, the accelerometer waits acceleration and if triggered sends interrupt to the SoC unit, if the SoC unit has its timer expired then it reads acceleration value from accelerometer, if the SoC unit gets an interrupt from accelerometer then the SoC unit reads acceleration value from accelerometer, then the SoC unit stores the acceleration value into non-transitory electronic memory and compares current acceleration value and last one from non-transitory electronic memory, if acceleration delta is greater than configured value in the SoC unit then the SoC unit instructs the GPS SoC unit to read the GPS location, if the GPS SoC unit gets GPS location then the SoC unit stores it into electronic non-transitory memory, then the SoC unit 3 compares current GPS location and last one from the electronic non-transitory memory, if the GPS location delta is greater than configured value in the SoC unit 3 then the SoC unit 3 updates its configuration.

10. The device as recited in claim 9, further comprising:
where the communication timer is triggered or GPS location delta threshold reached, the SoC unit searches for WiFi access points, if found it will connect then the SoC unit uploads all new data to a computering device.

11. The device as recited in claim 9, further comprising:
having the SoC unit 3 check for update, if there are, then the SoC unit downloads new configuration and updates it in the SoC unit's electronic non-transitory memory.

12. The device as recited in claim 9, further comprising:
where the data includes GPS location.

13. A device for tracking an item comprising:
the component of an accelerometer, a GPS SoC unit 2, SoC unit with WiFi radio, and an internal battery having the SoC unit check internal timers and waits expiration, the accelerometer waits acceleration and if triggered sends interrupt to the SoC unit, if the SoC unit has its timer expired then it reads acceleration value from accelerometer, if the SoC unit gets an interrupt from accelerometer then the SoC unit reads acceleration value from accelerometer, then the SoC unit stores the acceleration value into non-transitory electronic memory and compares current acceleration value and last one from non-transitory electronic memory, if acceleration delta is greater than configured value in the SoC unit then the SoC unit instructs the GPS SoC unit to read the GPS location, if the GPS SoC unit gets GPS location then the SoC unit stores it into electronic non-transitory memory, then the SoC unit 3 compares current GPS location and last one from the electronic non-transitory memory, if the GPS location delta is greater than configured value in the SoC unit 3 then the SoC unit 3 updates its configuration, where the communication timer is triggered or GPS location delta threshold reached, the SoC unit searches for WiFi access points, if found it will connect then the SoC unit uploads all new data to a computering device where the data includes GPS location.

14. The device as recited in claim 13, further comprising:
where the components are low power.

15. The device as recited in claim 13, further comprising:
where the battery is long lasting battery.

16. The device as recited in claim 13, further comprising:
where the components are connected and place in a tag.

17. The device as recited in claim 16, further comprising:
where the tag is placed on the item to be tracked.

18. The device as recited in claim 13, further comprising:
using a browser software application to connect to the Internet to convey information to the a computering device.

19. The device as recited in claim 13, further comprising:
having the SoC unit 3 check for update, if there are, then the SoC unit downloads new configuration and updates it in the SoC unit's electronic non-transitory memory.

20. A process to track an item using the device in claim 1.
